(19) United States
(12) Patent Application Publication
(10) Pub. No.: US 2001/0047460 A1
(43) Pub. Date: Nov. 29, 2001

(54) Remote copy system of storage systems connected to fibre network

(76) Inventors: Naotaka Kobayashi, Odawara (JP); Hiroshi Abei, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/819,808

(22) Filed: Mar. 29, 2001

(30) Foreign Application Priority Data
Apr. 25, 2000 (JP) 2000-128970

(51) Int. Cl. G06F 12/16; G06F 15/16; G06F 12/14; G06F 13/28

(52) U.S. Cl. 711/162; 709/250

(57) ABSTRACT

A plurality of storage systems are connected by a fibre channel so that remote copy can be made through the fibre channel. At the time of remote copy, World Wide Name is used in order for the storage systems to recognize each other and be connected together. The World Wide Name is information unique to port, and depends upon boards having ports. The storage system as the copy source sends a login request including other information than the World Wide Name from which the login from the storage system can be recognized, while the storage system on the login receiving side sends back information indicative of a port that can participate in the remote copy, so that a storage system and port hopeful for remote copy can be decided from the remote site only when the login from the storage system can be recognized.

### BACKGROUND OF THE INVENTION

1. Field of the Invention

The present invention relates to remote copy between storage units of a computer system.

2. Description of the Related Art

Volumes (stored data) of a storage system such as a disk storage unit of a computer system have so far been copied into another storage system in a remote place. This can deal wisely with the situation in which a disaster such as earthquake or other serious disorders occurs to disable the original storage system from normally operating so that data cannot be read from it. At this time, the data in the data-copied storage system can be used instead of the data in the original storage system. This copying of data or copied data is called remote copy. The remote copy is employed in a system particularly required to have high reliability, for example, a banking system.

As a conventional example of the remote copy between storage systems, there is a remote copy that makes use of ACONARC (Advanced Connection Architecture) technology, as disclosed in JP-A-6-236340.

Incidentally, the information transfer between host computer and storage system has recently been performed by use of fibre channel as a fast-transfer-purpose channel interface. The protocol of this fibre channel employs unique information based on its specification in order that the individual apparatus (nodes) or their ports sprinkled through the fibre channel can be distinguished from each other. Examples of this unique information are WWN (World Wide Name) and AL_PA (Arbitrated Loop Physical Address).

The fibre channel for use as data communication means has two great merits in performance and distance, or it can transmit data at fast speed (maximum speed of 100 MB/sec), and its cable can be extended to a long distance (up to 10 km by a single-unit cable, or to infinite by fabric connection). In a system using this fibre channel connected even between the previously mentioned storage system and host computer, these merits can be obtained.

### SUMMARY OF THE INVENTION

By the way, when remote copy is performed in a system, data transfer is required from a local storage system to a remote storage system. Thus, as compared with the case in which remote copy is not performed, the throughput of host I/O (input/output of data between host and storage system) is certainly reduced. The reason for this is that, in the case of remote copy, the write data held on the data cache that the storage system has therein remains on the data cache for a longer time than usual, or that the usage rate of data cache is poor. The remaining of write data in data cache for a long time is ascribed to the transfer performance of remote copy. As described above, ACONARC has so far been used for the remote connection in remote copy. The transfer rate of remote copy is very slow as compared with that of host I/O, and as a result, even if fibre channel is used for the transfer means between host computer and storage system, the transfer performance of host I/O is reduced because remote copy is performed.

In addition, although the cable length of ACONARC can be extended for long distant connection (over 10 km) by use of extender, the ACONARC-based apparatus are very costly. In this connection, use of fabric switch or hub in fibre channel leads to very low cost as compared with the use of ACONARC-based apparatus, and thus the effect is great even in the aspect of cost in the system architecture.

Therefore, the present invention is to restrict the host I/O throughput reduction to the minimum by using fibre channel for the data transfer of remote copy. In order to achieve the above object, according to the invention, an initiator port capable of communicating through a fibre channel is provided on a storage system as transfer source, and a target port connected to the fibre channel is provided on a storage system at a remote site, so that data can be transferred through a fibre channel protocol for establishing a link on the fibre channel. Moreover, the initiator port sends to the target port a login request including information from which its own system can be recognized as a storage system, while the target port sends back to the initiator an answer including hardware information that is unique to its own port and invariable when it recognizes the login issuing source as a storage system.

### BRIEF DESCRIPTION OF THE DRAWINGS

FIG. 1 is a diagram showing a system construction for environment architecture in an embodiment of the invention.

FIG. 2 is a detailed diagram showing a frame format and its data field used in the embodiment of the invention.

FIG. 3 is a diagram showing a login process used in the embodiment of the invention.

FIG. 4 is a diagram of another login process used in the embodiment of the invention.

FIG. 5 is a control flowchart on the login transmission side in the embodiment of the invention.

FIG. 6 is a control flowchart on the login receiving side in the embodiment of the invention.

FIG. 7 is a table showing the flow of target port detection in the embodiment of the invention.

FIG. 8 is a table management diagram showing the establishment of logical pass in the embodiment of the invention.

### DETAILED DESCRIPTION OF THE EMBODIMENTS

An embodiment of the invention will be described with reference to the accompanying drawings.

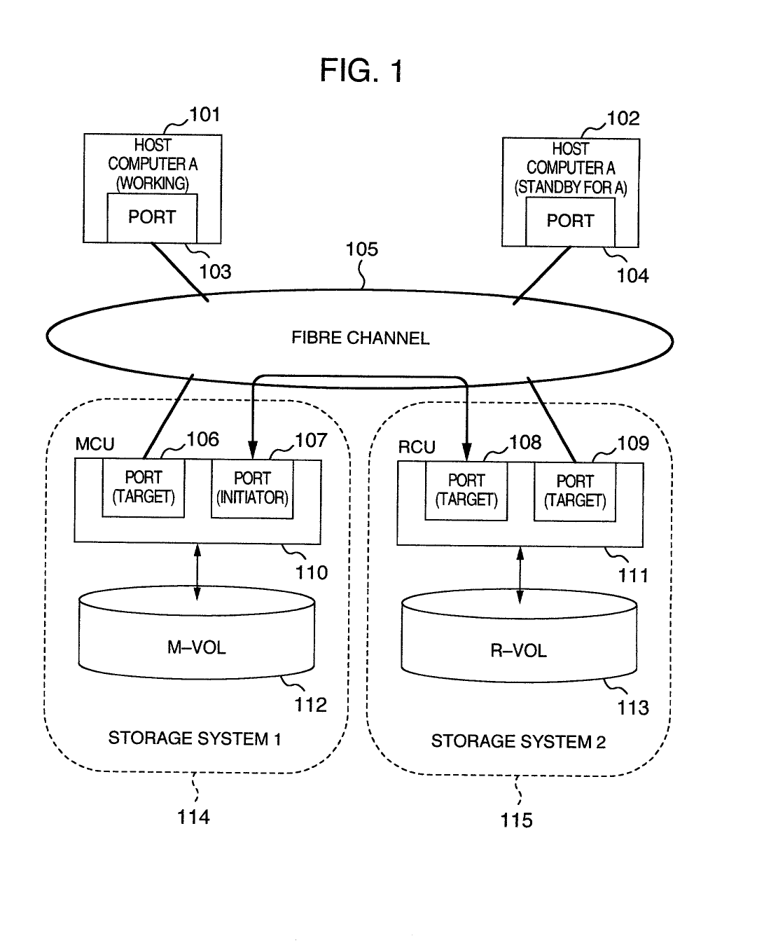

FIG. 1 shows the construction of a remote copy system as an embodiment of the invention. Host computers 101, 102 respectively have ports 103, 104 for a fibre channel interface, and are physically connected to storage systems 114 and 115 through the fibre channel interface. The storage systems 114, 115 also respectively have ports 106˜107, 108˜109 for the fibre channel interface as do the host computers 101, 102, and can be communicated according to the fibre channel protocol. Although there are some kinds of connections, such as point-to-point, arbitrated loop and fabric as the connection mode (topology) of the fibre channel interface between the host computers 101, 102 and the storage systems 114, 115, the fibre channel, 105 is simply used because the present invention does not depend on the connection mode.

This remote computer system is designed to copy through the fibre channel 105 a data volume (M-VOL 112) of the storage system 114 into a data volume (R-VOL 113) of the remote storage system 115. The host interface controller, as a master, of the storage system 114 has a port 107 serving as an initiator. This controller is called a master control unit (MCU) 110. The controller of the remote copy destination, or storage system 115 has a port 108 as a target. This controller is called a remote control unit (RCU) 111. The first feature of the present invention is to use the fibre channel in the interface protocol between MCU and RCU. Thus, this protocol will be briefly described.

The fibre channel is a protocol having a serial transfer system without its own command set, and has a characteristic capable of effectively using the band width of the transmitting medium in order to asynchronously transmit information. By use of the fibre channel as an infrastructure for command sets such as conventional SCSI, ACONARC, HIPPI, IP-3, and IP instead of its own command set, it is possible to make faster and more reliable versatile data transfer with the conventional protocol resources taken over.

The fibre channel is an interface having both the features of channel and network. The fibre channel can achieve fast transfer with little delay if the transfer source and transfer destination are once decided. This is the greatest feature of channel. An apparatus that desires to communicate can participate in a communication system of the fibre channel at an arbitrary time, exchange appointment information about the mutual communication with the opponent apparatus as a communication target, and start the communication. This is the feature of network. The procedure for the appointment information exchange about the communication with the opponent apparatus is called login.

The apparatus having the fibre channel interface (for example, host computer and the storage system) is called node, and the connector that makes actual interface operation is called port. The node is capable of having one or more ports. The maximum number of nodes that can simultaneously participate in all fibre channel system is, for example, equal to the number of addresses of 24 bits each, or about 16.77 millions. The fibre channel system is generally formed of some loop-shaped fibre channels. The hardware that connects the loops to relay information is called fabric. In practice, the ports of the transmission source and destination are constructed to operate considering only information about them without being conscious of the fabric. These ports are simply shown even in FIG. 1. Each node and each port respectively store worldwide unique identifiers that are assigned thereto according to a constant rule regulated by the Institute of Electrical and Electronics Engineers (IEEE). The identifiers correspond to the well-known MAC addresses in TCP/IP, and to addresses fixed on a hardware-basis. This address has two different values of N_Port_Name and Node_Name. The N_Port_Name is a specific value for port (hardware address) and Node_Name is a specific value for node (hardware address). Since these addresses are unique values in the world, they are called WWN (World Wide Name) as addresses by which the nodes or ports can be distinguished.

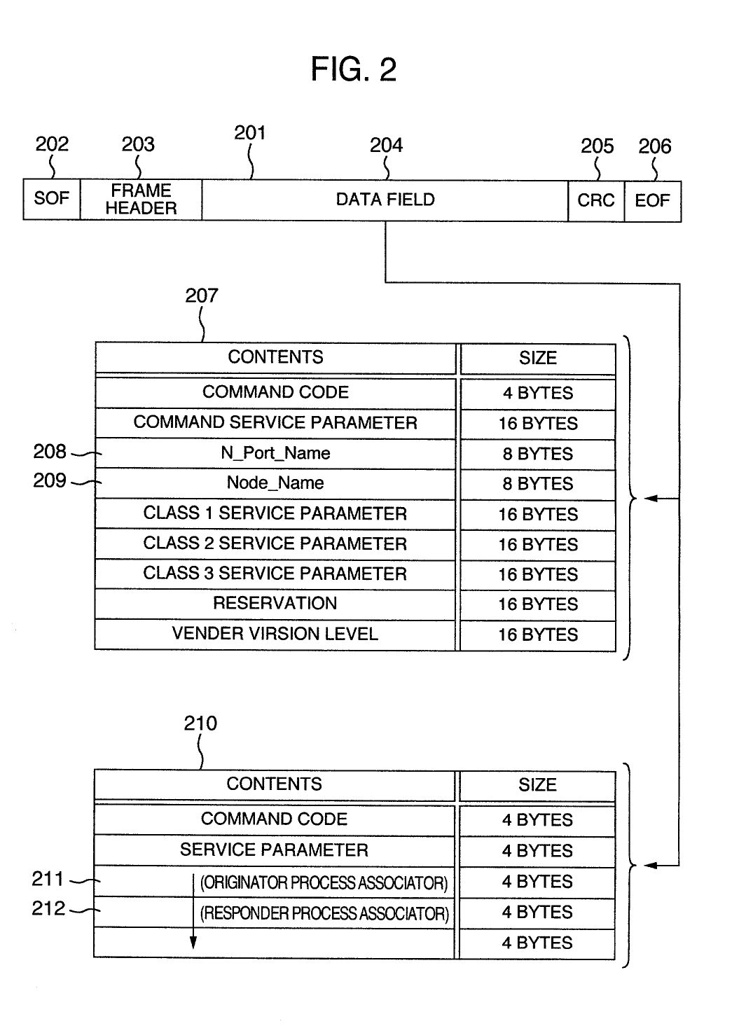

The communication through the fibre channel is performed to transmit and receive information of signal level called Ordered Set and logic information having a fixed format called frame. FIG. 2 shows the structure of frame. A frame 201 is formed of an identifier of 4 bytes called SOF (Start of Frame) 202 indicative of the start of frame, a frame header 203 of 24 bytes for controlling link operation and characterizing the frame, a data field 204 as a data portion to be actually transferred, a cyclic redundancy check code (CRC) 205 of 4 bytes, and an identifier of 4 bytes called EOF (End of Frame) 206 indicative of the end of frame. The data field 204 is variable from 0 to 2112 bytes.

A description will be made of the login procedure for exchanging information between the transmission source and destination systems on the basis of the fibre channel protocol, particularly about the structure of PLOGI (port login) frame and PRLI (process login) frame that are essential at the time of login procedure. As illustrated in FIG. 2 at a detailed structure 207 of PLOGI of data field 204, a region of 8 bytes ranging from the 21-st to the 29-th byte when counting from the head holds an N_Port_Name 208, and a region of 8 bytes ranging from the 30-th byte to the 38-th byte holds an Node_Name 209. As illustrated at a detailed structure 210 of PRLI, a region of 4 bytes ranging from the eighth byte to the eleventh byte from the head holds the parameter of an originator process associator 211. This region is a parameter area useful when a node is used as an initiator. A region of 4 bytes ranging from the twelfth byte to the fifteenth byte when counting from the head holds a parameter of a responder process associator 212. This area is a parameter area useful when a node is used as a target.

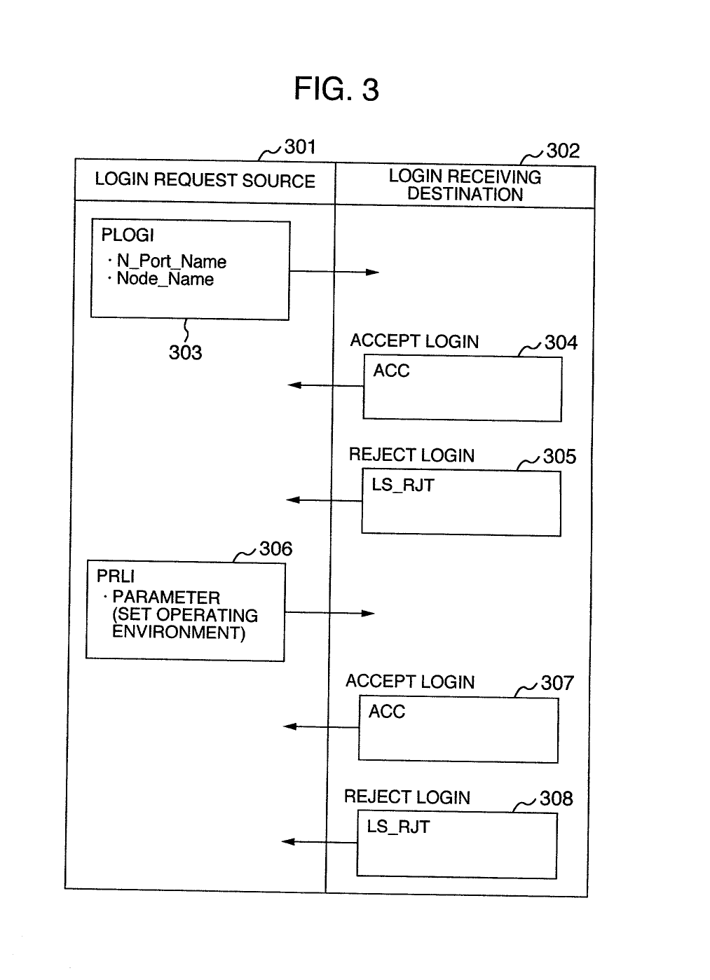

FIG. 3 shows the transmission and reception of information between a transmission source (login request source) 301 and a transmission destination (login receiving destination) 302. Although there are some kinds of fibre channel login procedures, we shall describe class-3 login here. The class-3 is one of the communication procedures of fibre channel, but the present invention is not particularly restricted to this type. For convenience of explanation, this type is illustrated.

The login request source transmits a PLOGI frame 303 to the login receiving destination. This frame includes the N_Port_and Node_Name of the login request source and other information. The receiving side apparatus extracts those information from the frame, and when accepting the login, it transmits a frame called ACC 304 to the login request source. When rejecting the login, it transmits a frame called LS_RJT 305 to the login request source. Whether the login is accepted or rejected is decided according to a rule of fiber channel that the target side has, and it has no direct relations with the present invention. When detecting the ACC frame as a response to the PLOGI frame, the login request source knows that the login is successful. When the login between ports is attained, a process-level exchange is performed. The login request source transmits a PRLI frame 306 to the login receiving destination. This frame includes information of FCP (fibre channel protocol)-level operation environment between process groups associated with two ports. The receiving side system transmits ACC 307 when accepting the login or LS_RJT frame 308 when rejecting, to the login request source. When the login procedure mentioned so far is successful, the state in which I/O process such as data transfer can be started is brought about. Thus, the general procedure between ports using the fibre channel is achieved.

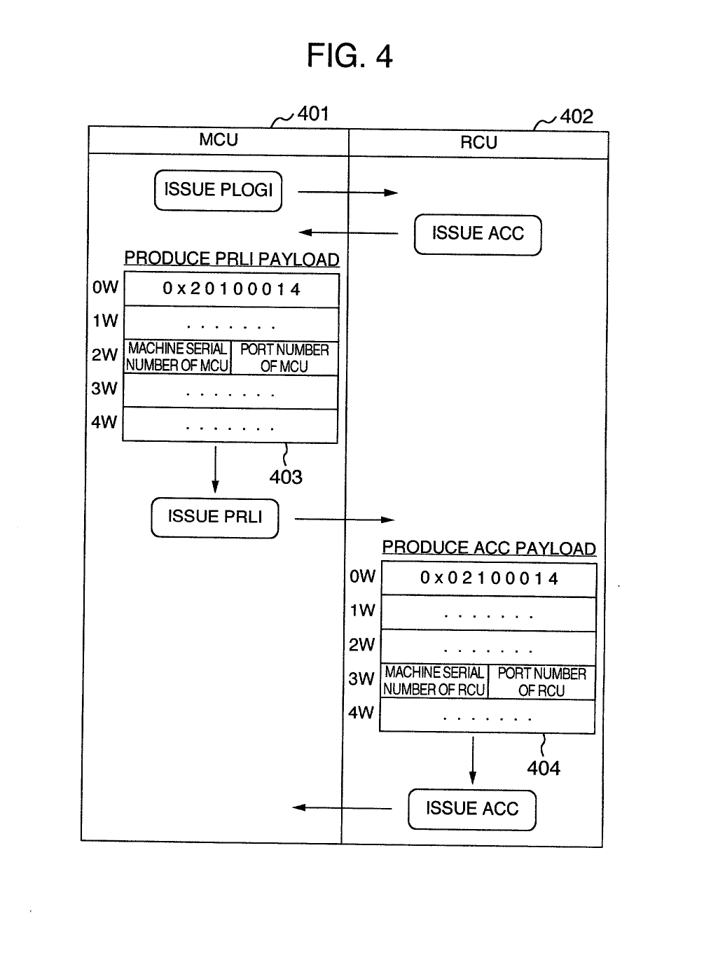

The remote copy using the fibre channel will be described below. FIG. 4 shows the exchange between MCU 401 and RCU 402 through the fibre channel. The MCU 401 and RCU 402 make a login procedure for establishing a path on the fibre channel. First, MCU 401 transmits PLOGI, and RCU 402 transmits ACC indicative of accepting PLOGI. This operation is equal to the case in which the host transmits PLOGI and the target device that have received it transmits ACC to the host. Then, MCU 401 transmits PRLI. In this case, according to the invention, in order to inform RCU of this storage system being MCU 401, the MCU transmits the machine serial number of MCU (which can be said to be the machine serial number of the storage system having MCU) and port number on the second W (parameter region of originator process associator) of a payload (actual data of data field) 403 of PRLI frame. The RCU 402 that has received PRLI frame cuts the second W of the payload away from the frame, and produces the machine serial number of MCU and the port number. Thus, the RCU can know that the initiator is MCU. The machine serial number is an identification number unique (specific) to hardware, and is constant irrespective of the change of fibre channel system or replacement of package. The machine serial number that cannot be usually identified in software is embedded in the transmission data so that it can be identified. Here, the machine serial number has a shade of meaning that it is specific identification information from which it can be known to be a storage system. While the machine serial number is used in this embodiment, other information, for example, an identifier other than the regulated identifier used in the fibre channel (the identifier used in the communication protocol of the fibre channel) may be used. Thus, the RCU decides whether the login is from MCU or host computer on the basis of the presence or absence of the machine serial number and port number. The MCU port number is unique to a storage system and unchanged.

The port number is identification information that indicates the position at which the port is mounted in the storage system, and it is defined as a location number unique in one storage system. If the storage system is capable of a maximum of 32 ports, the ports can be attached with numbers from one to 32. This port number is information indicative of location, and thus remains unchanged even if a port board having a separate N_Port_Name is mounted. The identification information indicated by N_Port_Name is equal to the address attached to each port, and depends on the hardware (for example, port board) constituting a port. Therefore, if a port board breaks down and hence is replaced by another port board, the address of this port is changed.

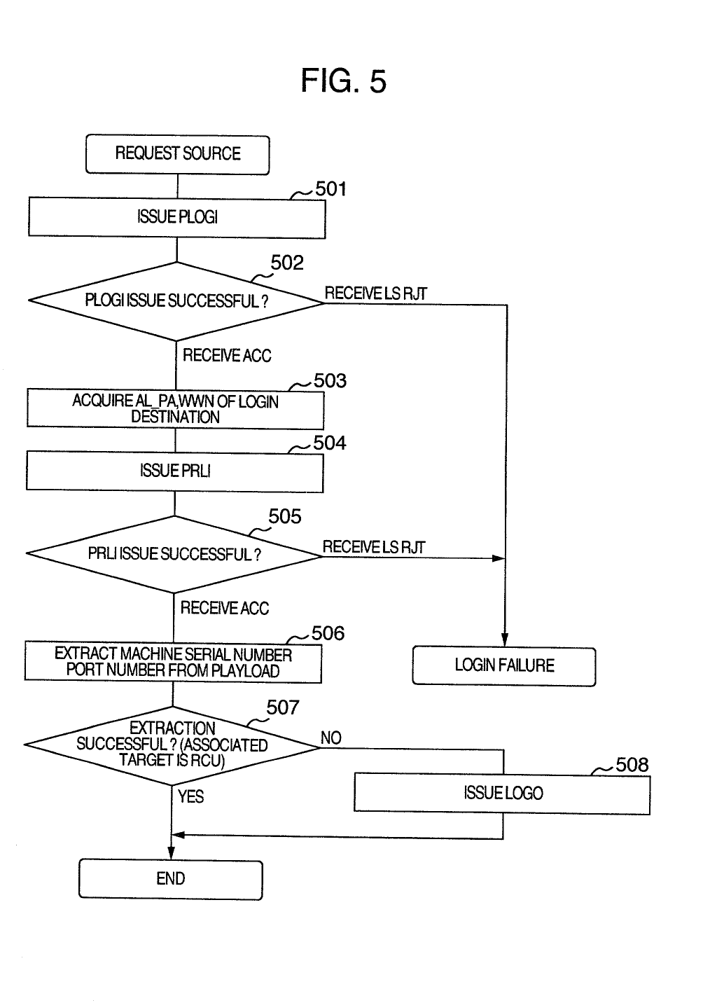

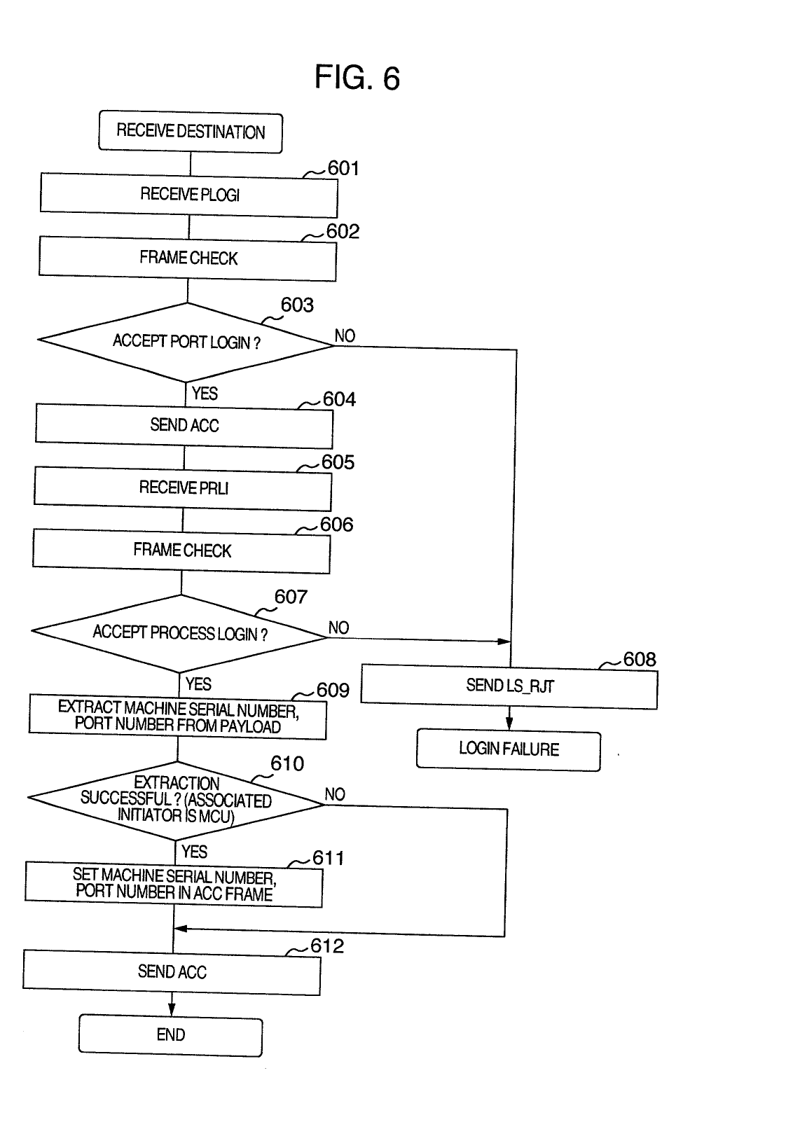

When the initiator that has transmitted PRLI is found to be MCU, the RCU transmits the RCU machine serial number and RCU port number on the third W (the parameter region of responder process associator) of a payload 404 of ACC frame. The MCU that has received the ACC frame cuts the third W of the payload away from the frame and produces the machine serial number and port number of the RCU. Thus, the MCU knows that the login opponent is one of the storage systems from which remote copy can be made, and it can specify the port of RCU. Thus, the target port identifying system is incorporated in the usual login procedure. The flow of this process will be described with reference to FIGS. 5 and 6 which are flowcharts of the halves of the process on the request and receiving sides, respectively.

As illustrated in the request-side process flow of FIG. 5, since the login procedure that the MCU performs aims to finally extract only the RCUs scattered on the fibre channel, the target port that can make remote copy is only a target port that can extract the machine serial number and port number from the ACC frame in an ACC response in response to the PRLI after the success of PLOGI. To the other target ports is issued LOGO (logout) for logout process. This login procedure is performed for all target ports on the fibre channel, and the target port that has extracted the machine serial number and port number actually becomes a prospect for part of the remote copy pair of RCU (in practice, a high-order application program specifies the storage systems which make remote copy from one to the other or vice versa).

The procedure will be described one by one with reference to FIG. 5. PLOGI is issued to a target port (501) like the procedure of FIG. 3. Decision is made of whether PLOGI issue is successful or not (502). In other words, if LS RJT is received, the process goes to login failure. If ACC is received, AL_PA, WWN of the login destination can be obtained from the ACC, and thus the opponent can be specified (503). Then, PRLI is issued (504), and decision is made of whether PRLI issue is successful or not (505). If LS RJT is received, the process goes to login failure. If ACC is received, the machine serial number and port number are extracted from the payload of ACC (506). Then, decision is made of whether the extraction is successful or not (507). If the extraction is successful, since the opponent is a storage system that can make remote copy, it comes up for remote copy destination. If the extraction fails, since the opponent is other than storage system, the process goes to logout (508). These operations are continuously repeated for all target ports as described above.

FIG. 6 is a flowchart showing the processing flow on the login receiving side. When the receiving side receives the login frame sent from the request source, it checks the frame contents, and decision is made of whether the login is accepted or rejected. In the present RCU, only when the request source, or initiator is MCU, the RCU informs to the MCU that the RCU operates as “RCU” for the MCU. If not so (usually login request from host), it responds as a mere target port. The process for the former case extracts the machine serial number and port number of MCU from PRLI frame. Only when they can be extracted, the machine serial number and port number of itself (RCU) is sent on ACC frame. This answer to login is sent to all initiators on the fibre channel. The initiator that has sent the machine serial number and port number back can form a pair of MCU and RCU for remote copy.

This process will be sequentially described with reference to FIG. 6. The receiving side receives PLOGI (601). It checks the frame (602), and it decides if it accepts the port login (603). If it rejects, LS RJT is sent (608), and the process goes to login failure. If it accepts, ACC is produced and sent (604). When PRLI is received (605), the frame is checked (606), and decision is made of whether the process login is accepted or rejected (607). If it is rejected, LS RJT is similarly sent (608), and the process goes to login failure. If it is accepted, the machine serial number and port number of the transmission source are extracted from the payload (609). If the extraction is successful (610), since this indicates that the initiator is MCU, its own machine serial number and port number are set in ACC frame (611) and sent the ACC (612). If the extraction is unsuccessful, since this indicates that login is from a node other than MCU, ACC with no machine serial number and port number set is transmitted (612). At this time, remote copy is not made even though the usual communication is possible.

As is above described, there is a reason for which the machine serial number and port number of RCU is used as the means for identifying RCU in MCU. The WWN as the address for uniquely identifying each port, and AL_PA as ID for all frames on each frame in the fibre channel are regulated in ANSI standard. These addresses are generally used for identifying ports on the fibre channel. The WWN is the information that can be obtained at the time of normal login (PLOGI) processing, and AL_PA is the information that can be received at the time of normal port initialization. These two kinds of identification information are unique on the fibre channel, but only those information cannot indicate that the associated target is RCU. Also, it cannot be assured that those values are invariant. Since WWN depends upon hardware, it may be changed at the time of hardware replacement. On the other hand, AL_PA have possibilities that when there are ports of the same value on a loop, it changes at the time of loop initialization. In this connection, the machine serial number and port number of apparatus are invariable information that do not depend on fibre channel. The logic of sending these information on PRLI frame back can be said to be the effective and most suitable method for RCU identification. While this embodiment specifies the identification information holding position such as the second word of PRLI frame payload 403, and the third word of ACC frame payload 404, the payload position is not necessary to be restricted. Here, it is only pointed out specifically that the target port can be designated by other information than the information such as WWN, AL_PA unique in the fibre channel.

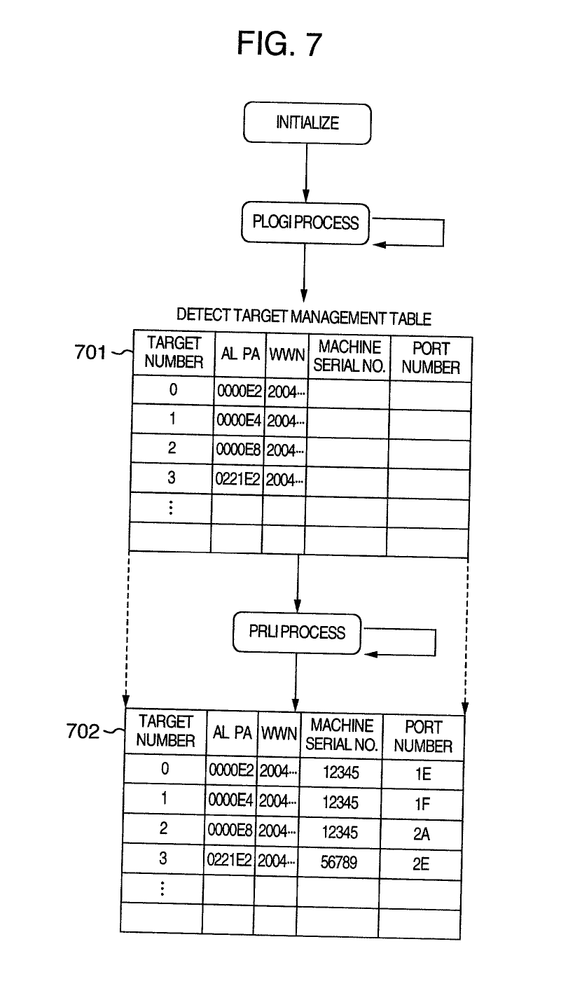

Thus, MCU can decide a RCU port from the target ports scattered on the fibre channel. MCU employs the table shown in FIG. 7 in order to manage the RCU detected on the fibre channel. A target management table 701 sequentially registers the AL_PA, WWN that are extracted from ACC frame of target sent in response to PLOGI. Then, the machine serial number and port number of only the target having effective responder process associator of ACC frame from tagrets in ACC response in response to also PRLI are extracted and registered to fill the corresponding columns of the target management table 701. As a result, RCU is found to be the targets corresponding to the target numbers of which the columns of the machine serial numbers and port numbers are filled with values as shown on a target management table 702. In FIG. 7, the same machine serial number is registered in three lines. This means that three ports of the same RCU (that is, the same storage system) having different port numbers can perform remote copy.

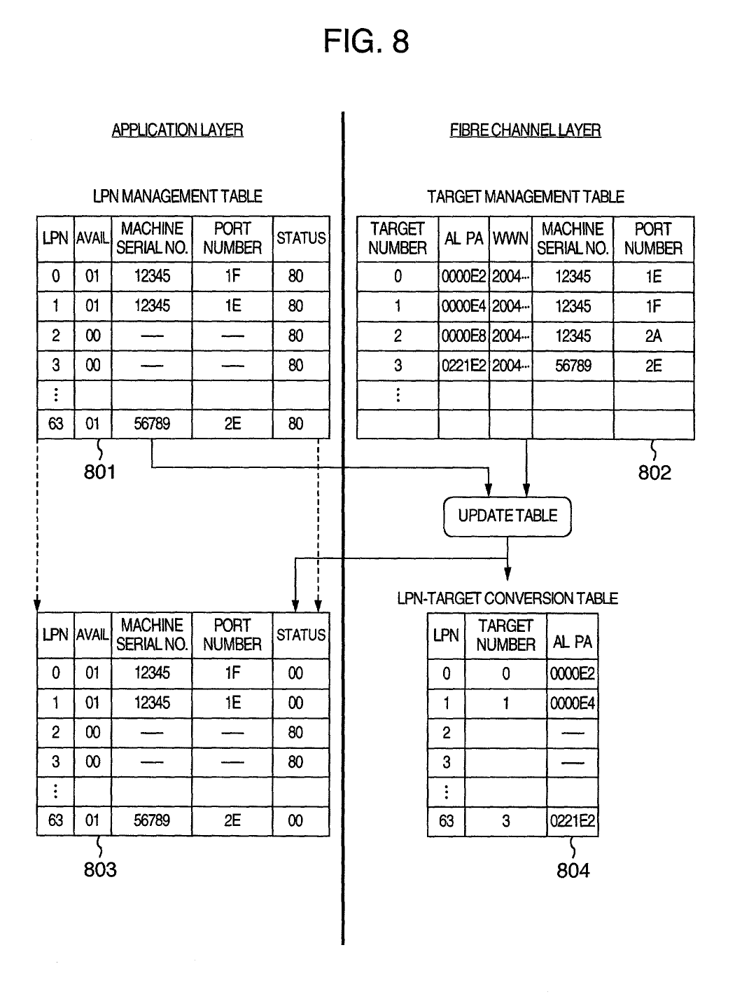

In the actual system, the path information (here, referred to as logic path (LPN)) for data communication between the initiator, or MCU and the target, or RCU is specified and managed on application level. Here, in this embodiment, an LPN (logic path) management table 801 shown in FIG. 8 is used as a reference table to which the user refers for setting.

FIG. 8 shows an application layer as a flow of information table of logic path that the user has set in MCU, and a fibre channel layer as a flow of RCU information and logic path information fixed on the fibre channel for the sake of convenience. An LPN management table 801 has target information (machine serial number, port number) of remote destination previously set. The avail of effective LPN (logic path) is expressed by 01, and the avail of LPN with no target information by 00. In addition, undetermined state on the fibre channel layer as status of LPN is expressed by 80, and the fixed state by 00.

A target management table 802 on the fibre channel layer has stored therein the destination address and the machine serial number and port number sent back in response to process login on the fibre channel. When an RCU is decided, only an LPN of the machine serial number and port number that can exist in both tables is made effective by referring to the LPN management table of application layer, thus updating an LPN-target conversion table 804. Only the LPNs determined on the LPN-target conversion table 804 become actually usable logic path. When the LPN-target conversion table 804 is updated, the fixed LPN information is also reflected on an LPN management table 803 of application layer, and the status values of LPN determined on the LPN management table 801 are changed from 80 to 00. Thus, the remote copy destination storage system and port can be specified. This example means that remote copy can be performed from a certain designated MCU to three target ports.

On the fibre channel, a link once established is necessary to be reestablished by an event of the participation of a new node or removal of the node from the link. In this case, too, the above login procedure is started. However, the validity of LPN can be assured by the table management shown in FIGS. 7 and 8.

Thus, according to the above embodiment of the invention, the remote copy between storage systems can be achieved even through the fibre channel. In addition, the merits of excellent transfer performance and long-distance connection that the fibre channel interface has can be fully utilized in the remote copy and host I/O by fibre channel connection.

What is claimed is:

1. A remote copy system of storage systems comprising:
a host computer;
a storage system having a port as an initiator of remote copy;
another storage system having a target port; and
a fibre channel through which said host computer and said storage systems are connected, wherein said storage system having said port as said initiator has a controller by which a login request including first information from which said storage system can be recognized as a storage system is sent to said target port of said other storage system, and said other storage system having said target port has a controller by which an answer including second information that is unique to hardware and invariable and capable of specifying said target port is sent back when said other storage system recognizes said login source as storage system from said first information of said login request.

2. A remote copy system of storage systems according to claim 1, wherein said second information is an identifier and port number that are unique to hardware of said storage system having said target port.

3. A remote copy system of storage systems according to claim 1, wherein said second information is a machine serial number and port number of said storage system having said target port.

4. A remote copy system of storage systems according to claim 1, wherein said first information is an identifier and port number unique to hardware of said storage system having said initiator port.

5. A remote copy system of storage systems according to claim 1, wherein said first information is a machine serial number and port number of said storage system having said initiator port.

6. A remote copy system of storage systems according to any one of claims 3, 4 and 5, wherein said port number is an identification number of location that indicates the position at which said initiator port of said storage system is mounted.

7. A remote copy system of storage systems comprising:
a host computer:
a storage system serving as a copy source of remote copy, and having a master control unit;
another storage system having a target port; and
a fibre channel through which said host computer, and said storage systems are connected, wherein said master control unit sends a login request from an initiator port to said target port together with additional information indicative of said login being from said master control unit, and said storage system having said target port, upon recognition of login from said master control, sends back to said initiator an answer including information that is unique to hardware and variable and capable of specifying said target port as a storage system to be participated in remote copy.

8. A remote copy system of storage systems according to claim 7, wherein said information indicative of the login from said master control unit is an identifier and port number unique to said master control unit.

9. A remote copy system of storage systems according to claim 8, wherein said port number is an identification information of location that indicates the position at which said port of said master control unit is mounted.

10. A remote copy system of storage systems according to claim 7, wherein said information indicative of the login from said master control unit is an identifier other than an identifier used in a fibre channel communication protocol.

11. A remote copy system of storage systems comprising:
a host computer;
a plurality of storage systems each having a control unit; and
a fibre channel through which said host computer and said plurality of storage systems are connected, wherein the control unit of a storage system of said plurality of storage systems as a copy source of remote copy sends a login request including an identifier and port number unique to said control unit to a port of another one of said plurality of storage systems, and the control unit of said another one of said storage systems sends back to said control unit of said copy source an answer including an identifier and port number unique to said control unit of said another one of said storage systems when said identification number and port number unique to the control unit of said copy source are found in said login data.

12. A remote copy system of storage systems comprising:
a host computer;
a plurality of storage systems each having a control unit; and
a fibre channel through which said host computer and said plurality of storage systems are connected;
a control unit of one of said plurality of storage systems as a copy source of remote copy for sendig a login request including information indicative of a login from a storage system to a port of another one of said plurality of storage systems;
a control unit of said another one of said plurality of storage systems for sending back to said control unit of said storage system as said copy source an answer including an identifier and a port number unique to said control unit of said another storage system when said information from which the login from said storage system can be found in data of said login;
a target management table for storing said identifier and port number unique to said control unit of said another storage system that are included in said answer, and a destination address of said port;
a logic path management table for storing an identifier and a port number unique to a copy destination control unit specified by an application layer; and
a logic-path-to-target conversion table for storing a target port having an identifier and a port number unique to said copy destination control unit as a copy destination port in common with said target management table and said logic path management table.

13. A remote copy system of storage systems according to any one of claims 11 and 12, wherein said port number unique to said control unit of said storage system as said copy source is identification information of location that indicates a position at which a port of said control unit of said storage system is mounted on said control unit.

14. A remote copy system of storage systems according to any one of claims 11 and 12, wherein said port number unique to said control unit of said another storage system different from said copy source is identification information of location that indicates a position at which a port of said control unit of said another storage system is mounted on said control unit of said another storage system.
